(19) United States
(12) Patent Application Publication
(10) Pub. No.: US 2008/0055156 A1
(43) Pub. Date: Mar. 6, 2008

(54) Apparatus, system and method adapted to use location information to determine frequency channels and modes of reception of television signals

(76) Inventor: Debarag N. Banerjee, Sunnyvale, CA (US)

Correspondence Address: INTEL CORPORATION;c/o INTELLEVATE, LLC, P.O. BOX 52050, MINNEAPOLIS, MN, 55402, US

(21) Appl. No.: 11/517,151

(22) Filed: Sep. 5, 2006

(51) Int. Cl. G01S 5/14

(52) U.S. Cl. 342/357.06

(57) ABSTRACT

An embodiment of the present invention provides an apparatus, comprising a geolocation receiver and a television receiver, wherein the television receiver is adapted to use location information provided by the geolocation receiver to determine frequency channels and modes of reception of television signals. An embodiment of the present invention may further comprise a processor and memory adapted to use the location information from the geolocation receiver and look up certain information stored in the memory to configure the television receiver appropriately using the looked up information.

### BACKGROUND

Mobile computing and mobile communications have become pervasive throughout society. Mobile computing now provides more than just crunching numbers. Mobile computers have the ability to send and receive and process information wirelessly. This includes the ability to receive television (TV) signals. Currently the user of a mobile apparatus is required to manually select the frequency channel, or scan from a large a priori collection, which may vary from location to location. Changing the demodulation scheme is done manually at the time, and most current devices have limited modulation scheme choices.

Thus, a strong need exists for an apparatus, system and method adapted to use location information to determine frequency channels and modes of reception of television signals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of apparatus or platform adapted to use location information to determine frequency channels and modes of reception of television signals of one embodiment of the present invention; and

FIG. 2 illustrates a flowchart of the method according to one embodiment of the present invention; and

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN), wireless metropolitan area networks (WMAN) and Mesh networks.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

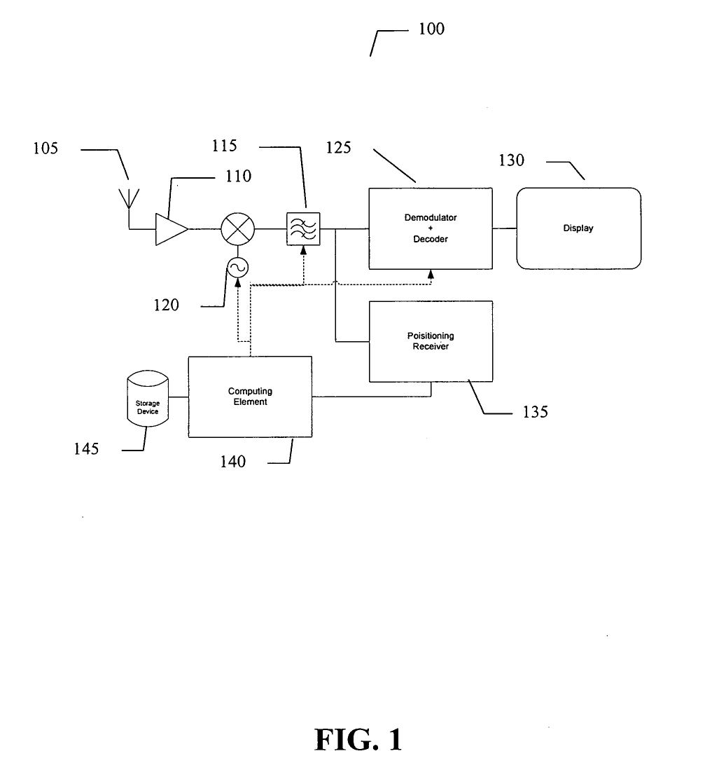

An embodiment of the present invention provides, as shown in FIG. 1, a mobile platform 100 such as, but not limited to, a notebook, UMPC or handheld device which may consist of at least of a radio frequency (RF) front-end amplifier 110, frequency synthesizer and tuner 120, channel selection filter 115, television receiver 125 such as a DVB-H/ISDB-T/T-DMB/DMB-TH receiver connected to antenna 105, a position receiver 135, such as geolocation receiver such as a global position system (GPS) receiver, a computing element 140 such as a processor or a System on a Chip (SoC), and memory 145 for storing and retrieving non-volatile data such as a hard disc drive or flash memory. A demodulator/decoder is provided at 125 to demodulate and decode the TV signals to be displayed on display 130.

An embodiment of the present invention may include a geolocation receiver consisting of a combination of the receiver components 105, 110, 120 and 115 or a similar combination of parallel entities and determining the location of the platform device. The computing element 140 may use the location thus obtained to look up certain information stored in the storage device 145 and configure the television receiver 110 appropriately using the looked up information.

In an embodiment of the present invention and not limited in this respect, the geolocation receiver 135 may be a GPS receiver. In yet another embodiment, the geolocation receiver 135 may be a terrestrial TV signal receiver. The information stored in the storage device 145 may be a lookup table of TV bands (such as VHF, UHF, L1/L2 bands etc.), frequency plans, modulation mechanisms and signal-to-noise ratios of available channels against geographical location, although it is understood that the present invention is not limited any particular information which the storage device 145 may contain. The configuration of the television receiver 110 may include changing the frequency 120 of operation and the demodulation algorithm. Further, in an embodiment of the present invention, the computing element 140 may be a general purpose processor embedded in the platform 100. In yet another embodiment of the present invention, the computing element 140 may be a System on a Chip (SoC) that performs both geolocation and TV reception functions. Thus, the present invention may allow channel frequency and demodulation scheme selection to be performed semi-automatically, where the platform 100 would offer the use only a small subset of relevant choices specific to the geography in which the device 100 is being operated.

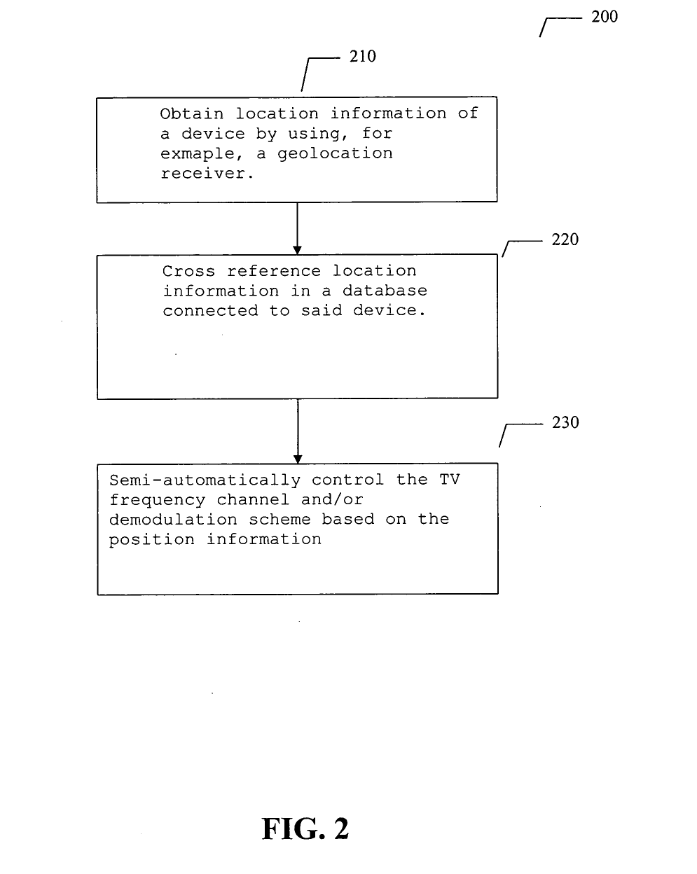

Yet another embodiment of the present invention provides a method, shown generally in FIG. 2 as 200, comprising using location information provided by a geolocation receiver 210 to enable a television receiver to determine frequency channels and modes of reception of television signals based on the location information 230 by cross referencing 220 the position information with a data base in memory associated with a platform, such as a mobile computing device. The present method may further comprise using a global positioning system (GPS) receiver as the geolocation receiver and may use GPS satellite transmission synchronization signals to determine the geolocation location information.

Still another embodiment of the present invention provides, a machine-accessible medium that provides instructions, which when accessed, cause a machine to perform operations comprising, using location information provided by a geolocation receiver to enable a television receiver to determine frequency channels and modes of reception of television signals based on the location information.

Yet another embodiment of the present invention provides a system, comprising a geolocation receiver, a television receiver connected to the geolocation receiver, and a computer adapted to receive information from the geolocation receiver and instructing the television receiver to use frequency channels and modes of reception of television signals in areas designated for a specific location.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. An apparatus, comprising:
a geolocation receiver; and
a television receiver, wherein said television receiver is adapted to use location information provided by said geolocation receiver to determine frequency channels and modes of reception of television signals.

2. The apparatus of claim 1, wherein said geolocation receiver is a global positioning system (GPS) receiver.

3. The apparatus of claim 2, wherein said geolocation receiver uses GPS satellite transmission synchronization signals.

4. The apparatus of claim 2, wherein said television receiver is a DVB-H, ISDB-T, T-DMB and/or DMB-TH receiver.

5. The apparatus of claim 1, further comprising a processor and memory adapted to use the location information from said geolocation receiver and look up certain information stored in said memory to configure the television receiver appropriately using the looked up information.

6. The apparatus of claim 1, wherein said geolocation receiver is a terrestrial TV signal receiver and the synchronization signals are the TV synchronization signals.

7. The apparatus of claim 5, wherein said information stored on said memory is a lookup table of TV bands, frequency plans, modulation mechanisms and signal-to-noise ratios of available channels against geographical location.

8. The apparatus of claim 1, wherein the configuration of the television receiver includes the capability of changing a frequency of operation and a demodulation algorithm.

9. The apparatus of claim 5, wherein said processor is a computing element that is a general purpose processor embedded in said apparatus.

10. A method, comprising:
using location information provided by a geolocation receiver to enable a television receiver to determine frequency channels and modes of reception of television signals based on said location information.

11. The method of claim 10, further comprising using a global positioning system (GPS) receiver as the geolocation receiver.

12. The method of claim 11, further comprising using GPS satellite transmission synchronization signals to determine said geolocation location information.

13. The method of claim 10, further comprising using a processor and memory adapted to use the location information from said geolocation receiver and look up certain information stored in said memory to configure the television receiver appropriately using the looked up information.

14. The method of claim 10, further comprising using a terrestrial TV signal receiver to provid said geolocation information and using TV synchronization signals as the synchronization signals.

15. The method of claim 13, further comprising storing a lookup table of TV bands, frequency plans, modulation mechanisms and signal-to-noise ratios of available channels against geographical location said information stored on said memory.

16. A machine-accessible medium that provides instructions, which when accessed, cause a machine to perform operations comprising:
using location information provided by a geolocation receiver to enable a television receiver to determine frequency channels and modes of reception of television signals based on said location information.

17. The machine-accessible medium of claim 16, further comprising said instructions causing said machine to perform operations further comprising using a global positioning system (GPS) receiver as the geolocation receiver.

18. The machine-accessible medium of claim 16, further comprising said instructions causing said machine to perform operations further comprising using GPS satellite transmission synchronization signals to determine said geolocation location information.

19. The machine-accessible medium of claim 16, further comprising said instructions causing said machine to perform operations further comprising using a processor and memory adapted to use the location information from said geolocation receiver and look up certain information stored in said memory to configure the television receiver appropriately using the looked up information.

20. The machine-accessible medium of claim 16, further comprising said instructions causing said machine to perform operations further comprising using a terrestrial TV signal receiver to provid said geolocation information and using TV synchronization signals as the synchronization signals.

21. The machine-accessible medium of claim 19, further comprising said instructions causing said machine to perform operations further comprising storing a lookup table of TV bands, frequency plans, modulation mechanisms and signal-to-noise ratios of available channels against geographical location said information stored on said memory.

22. A system, comprising:
a geolocation receiver;
a television receiver connected to said geolocation receiver; and
a computer adapted to receive information from said geolocation receiver and instructing said television receiver to use frequency channels and modes of reception of television signals in areas designated for a specific location.

23. The system of claim 22, further comprising an omni-directional antenna connected to said geolocation receiver

24. The system of claim 22, further comprising memory associated with said computer and wherein information stored on said memory is a lookup table of TV bands, frequency plans, modulation mechanisms and signal-to-noise ratios of available channels against geographical location.
